(19) United States
(12) Patent Application Publication
(10) Pub. No.: US 2018/0276119 A1
(43) Pub. Date: Sep. 27, 2018

(54) DISTRIBUTED GARBAGE COLLECTION FOR UNBALANCED WORKLOAD

(71) Applicant: INTERNATIONAL BUSINESS MACHINES CORPORATION, Armonk, NY (US)

(72) Inventors: Kiyokuni Kawachiya, Tokyo (JP); Mikio Takeuchi, Tokyo (JP)

(21) Appl. No.: 15/465,873

(22) Filed: Mar. 22, 2017

(51) Int. Cl. G06F 12/02; G06F 9/455

(52) U.S. Cl. CPC G06F 12/0261; G06F 2212/152; G06F 2212/1044; G06F 9/45504

(57) ABSTRACT

A computer-implemented method is provided for distributed garbage collection (GC). The method includes increasing, an amount of heap collection in an origin JAVA Virtual Machine (JVM) by collecting unnecessary remote references to objects that belong to the origin JVM. The collecting step collects the unnecessary remote references by executing a local GC in one or more remote JVMs.

### BACKGROUND

### Technical Field

The present invention relates generally to information processing and, in particular, to distributed garbage collection for an unbalanced workload.

### Description of the Related Art

X10 is a programming language that performs parallel computing using the Partitioned Global Address Space (PGAS) model. A computation is divided among a set of places, each of which holds some data and hosts one or more activities that operate on that data.

Managed X10 is an X10 implementation on JAVA (i.e., managed runtime). An X10 program is translated into JAVA source code, compiled into JAVA bytecode, and then executed on multiple JAVA Virtual Machines (JVMs). Hence, X10 data is represented by JAVA objects and collected by each JVMs garbage collection (GC).

In Managed X10, it is possible to represent a “remote” reference to an object in a different JVM. In order to disable an erroneous collection of an object with a remote reference by a local GC in the origin JVM, when a normal (local) reference is copied to a different (that is, “remote”) JVM, the local reference is registered to the GC root of the origin JVM. An unnecessary remote reference is collected by a local GC in the remote JVM with a weak reference mechanism, and it is notified to the origin JVM and the local reference is deregistered from the GC root of the origin JVM in order to re-enable a collection of the object by a local GC in the origin JVM.

In the above scenario, the collection of a remote reference is done by a local GC in the remote JVM, which is triggered b the lack of heap space in the remote JVM that is independent from the heap space in the origin JVM. Therefore if the heap consumption speed in the origin JVM is faster than that in the remote JVM, an out-of-memory error could happen in the origin JVM because of unnecessary remote references that are not collected by the latest local GC in the remote JVM.

Thus, there is a need for an improved garbage collection approach that overcomes the aforementioned deficiencies.

### SUMMARY

According to an aspect of the present invention, a computer-implemented method is provided for distributed garbage collection (GC). The method includes increasing an amount of heap collection in an origin JAVA Virtual Machine (JVM) by collecting unnecessary remote references to objects that belong to the origin JVM. The collecting step collects the unnecessary remote references by executing a local GC in one or more remote JVMs.

According to another aspect of the present invention, a computer-implemented method is provided for distributed garbage collection (GC). The method includes increasing an amount of heap collection in an origin JAVA Virtual Machine (JVM) by collecting unnecessary remote references to the objects that belong to the origin JVM. The collecting step collects the unnecessary remote references by concurrently executing a local GC in all JVMs, including the origin JVM and one or more remote JVMs, when the local GC is requested in any of the JVMs from among the origin JVM and the one or more remote JVMs.

According to yet another aspect of the present invention, a computer-implemented method is provided for distributed garbage collection (GC). The method includes increasing an amount of heap collection in an origin JAVA Virtual Machine (JVM) by collecting unnecessary remote references to the objects that belong to the origin JVM. The collecting step collects the unnecessary remote references by autonomously executing a local GC in all JVMs, including the origin JVM and one or more remote JVMs, at each iteration of a same algorithm or at a barrier synchronization point.

According to still another aspect of the present invention, a compiler is provided in a computer processing system. The compiler includes a garbage collector for managing memory in the computer processing system. The garbage collector is configured to increase an amount of heap collection in an origin JAVA Virtual Machine (JVM) by collecting unnecessary remote references to the objects that belong to the origin JVM. The unnecessary remote references are collected by executing a local GC in one or more remote JVMs.

According to a further aspect of the present invention, a compiler is provided in a computer processing system. The compiler includes a garbage collector for managing memory in the computer processing system. The garbage collector is configured to increase an amount of heap collection in an origin JAVA Virtual Machine (JVM) by collecting unnecessary remote references to the objects that belong to the origin JVM. The unnecessary remote references are collected by: (i) concurrently executing a local GC in all JVMs, including the origin JVM and one or more remote JVMs, when the local GC is needed in any of the JVMs from among the origin JVM and the one or more remote JVMs, or (ii) autonomously executing the local GC in all of the JVMs, at each iteration of a same algorithm or at a barrier synchronization point.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows an exemplary processing system to which the present invention may be applied, in accordance with an embodiment of the present invention;

FIG. 2 shows an exemplary managed X10 compiler to which the present invention can be applied, in accordance with an embodiment of the present invention;

FIGS. 3-4 show an exemplary method for distributed garbage collection for an unbalanced workload, in accordance with an embodiment of the present invention;

FIG. 5 shows another exemplary method for distributed garbage collection for an unbalanced workload, in accordance with an embodiment of the present invention;

FIG. 6 shows yet another exemplary method for distributed garbage collection for an unbalanced workload, in accordance with an embodiment of the present invention;

FIG. 7 shows still another exemplary method for distributed garbage collection for an unbalanced workload, in accordance with an embodiment of the present invention and

FIG. 8 shows still yet another exemplary method for distributed garbage collection for an unbalanced workload, in accordance with an embodiment of the present invention.

### DETAILED DESCRIPTION

The present invention is directed to distributed garbage collection for an unbalanced workload.

In X10, an object belongs to a place where it is created. An object cannot be accessed from other places, but the object can be remotely referenced from other places, using remote reference. Remote reference (called GlobalRef in X10) has a problem in Managed X10 in that an out-of-memory error can be caused in one or more allocation intensive JVMs if the workload is unbalanced between participating JVMs. The present invention solves the problem by requesting other (i.e., remote) JVMs perform a local GC to collect unused remote references early. That is, the present invention can advantageously prevent an out-of-memory error in the origin JVM which is caused by unnecessary remote references that are not collected by the latest local GC in the remote JVM.

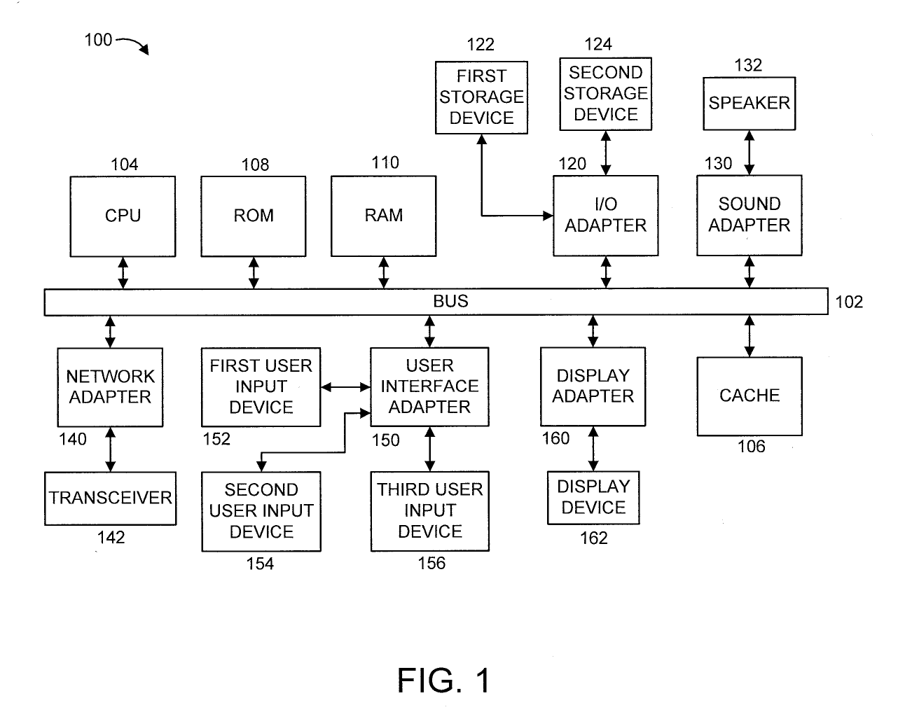

FIG. 1 shows an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

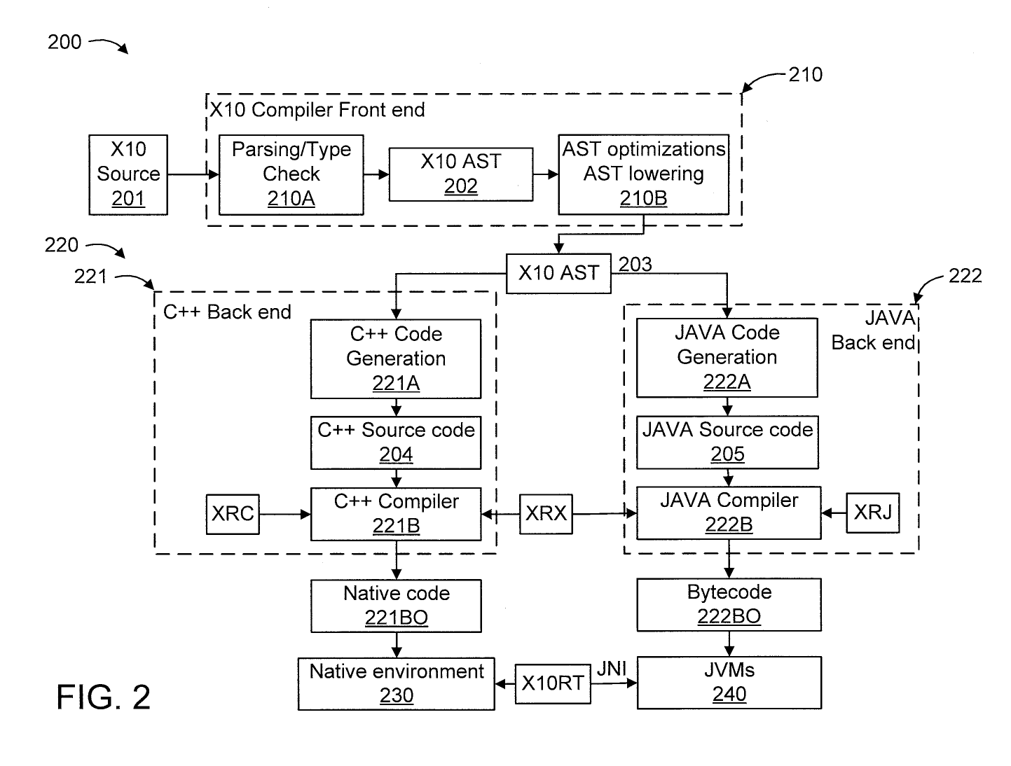

Moreover, it is to be appreciated that compiler 200 described below with respect to FIG. 2 is a compiler for implementing respective embodiments of the present invention. Part or all of processing system 100 may be implemented in one or more of the elements of compiler 200.

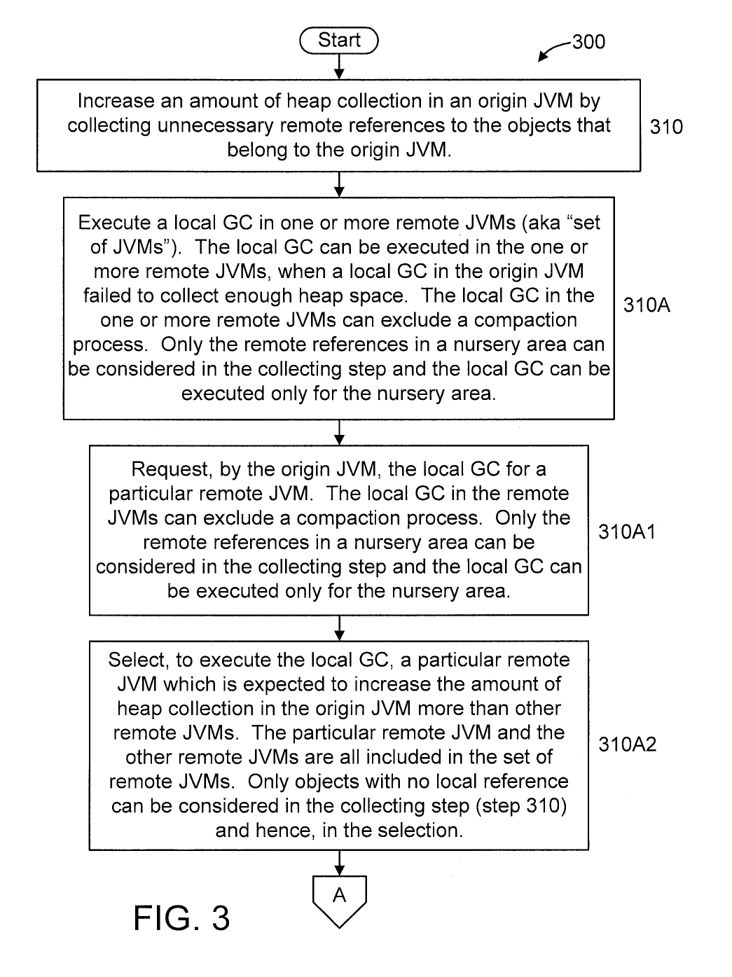

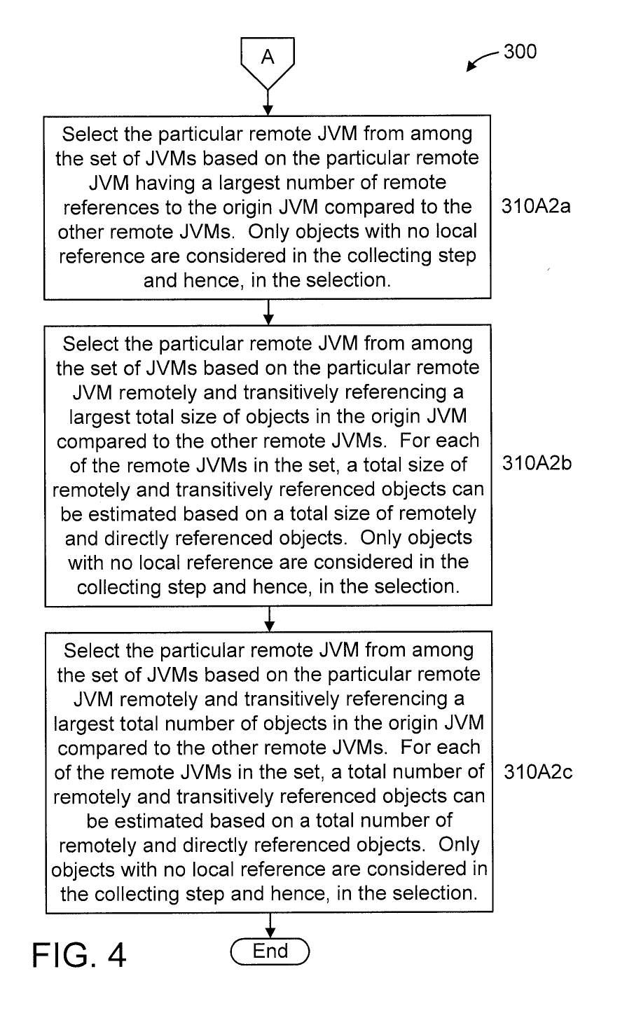

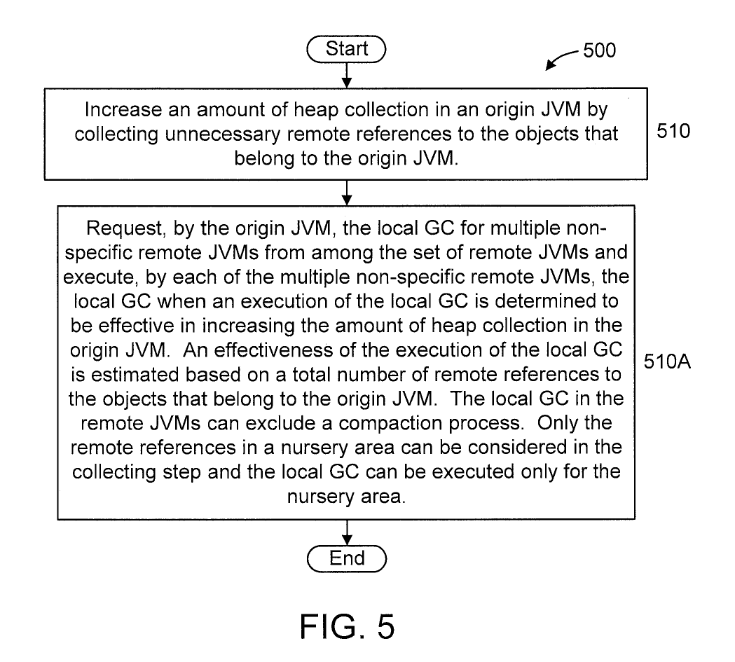

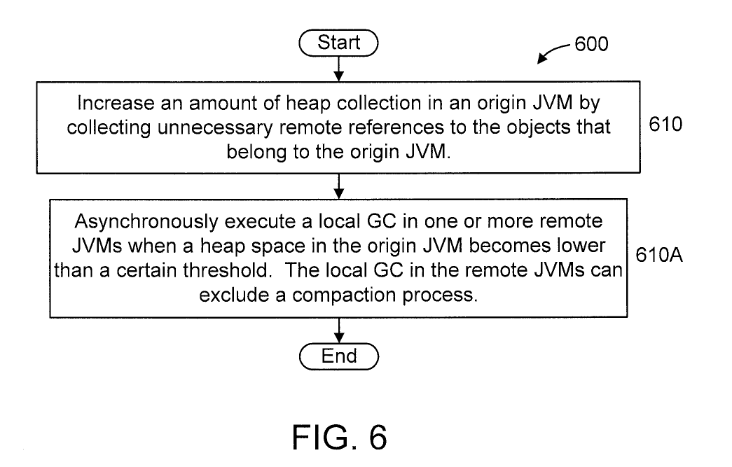

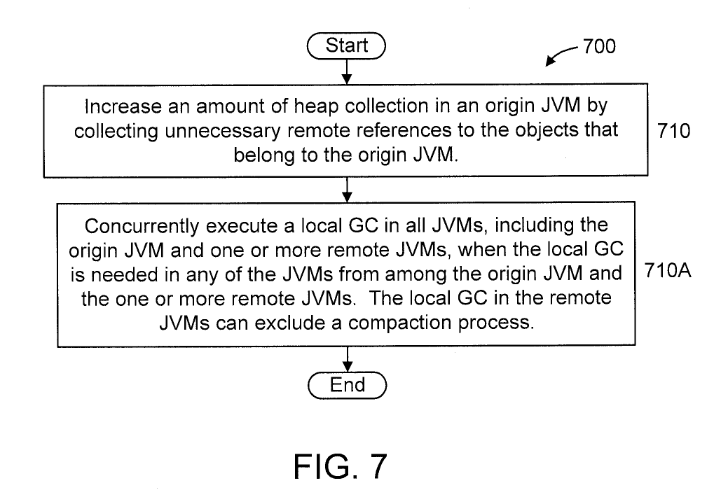

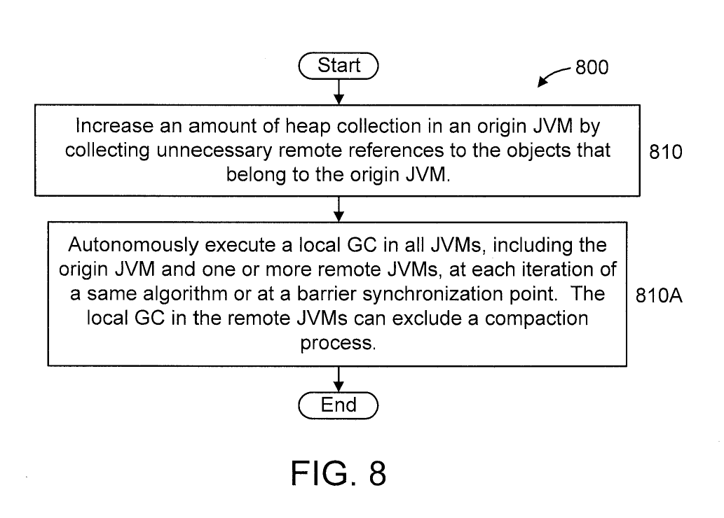

Further, it is to be appreciated that processing system 100 may perform at least part of the method described herein including, for example, at least part of method 300 of FIGS. 3-4 and/or at least part of method 500 of FIG. 5 and/or at least part of method 600 of FIG. 6 and/or at least part of method 700 of FIG. 7 and/or at least part of method 800 of FIG. 8 and/or at least part of method 800 of FIG. 8. Similarly, part or all of compiler 200 may be used to perform at least part of method 300 of FIGS. 3-4 and/or at least part of method 500 of FIG. 5 and/or at least part of method 600 of FIG. 6 and/or at least part of method 700 of FIG. 7 and/or at least part of method 800 of FIG. 8 and/or at least part of method 800 of FIG. 8.

FIG. 2 shows an exemplary managed X10 compiler 200 to which the present invention can be applied, in accordance with an embodiment of the present invention.

In FIG. 2, the following representations are used:
JNI: JAVA Native Interface;
AST: Abstract Syntax Tree;
XRX: X10 Runtime in X10;
XRJ: X10 Runtime in JAVA;
XRC: X10 Runtime in C++; and
X10RT: X10 Communications Runtime.

The compiler 200 includes two main parts, namely an AST-based front end and optimizer 210 and C++/JAVA back ends 220.

The AST-based front end and optimizer 210 parses and type checks 210A X10 source code 201 to output X10 AST 202 on which AST based optimizations and AST lowering 210B are performed to output optimized X10 AST 203.

The C++/JAVA back ends 220 translate the optimized X10 AST 203 into C++/JAVA source code and invoke a post compilation process that either uses a C++ compiler to produce an executable binary (native code) or a JAVA compiler to produce bytecode. To that end, the C++/JAVA back ends 220 include a C++ back end 221 and a JAVA back end 222.

Regarding the C++ back end 221, the same includes a C++ code generator 221A that outputs C++ source code 204 to a C++ compiler 221B. The C++ compiler 221B outputs the binary (native) code 221BO that is executed in a native environment 230.

Regarding the JAVA back end 222, the same includes a JAVA code generator 222A that outputs JAVA source code 205 to a JAVA compiler 222B. The JAVA compiler 222B outputs the bytecode 222BO that is executed by JVMs 240.

FIGS. 3-4 show an exemplary method 300 for distributed garbage collection for an unbalanced workload, in accordance with an embodiment of the present invention. The unbalanced workload is between participating JVMs, which include an origin JVM and one or more remote JVMs.

At step 310, increase an amount of heap collection in an origin JVM by collecting unnecessary remote references to the objects that belong to the origin JVM.

In an embodiment, step 310 includes step 310A.

At step 310A, execute a local GC in one or more remote JVMs. The one more remote JVMs, form a set of remote JVMs and are, thus, interchangeably referred to as the “one or more remote JVMs” and the “set of JVMs”. In an embodiment, the local GC can be executed in the one or more remote JVMs, when a local GC in the origin JVM failed to collect enough heap space. In an embodiment, the local GC in the remote JVMs can exclude a compaction process. In an embodiment, only the remote references in a nursery area can be considered in the collecting step (step 310) and the local GC can be executed only for the nursery area.

In an embodiment, step 310A can include one or more of steps 310A1 and step 310A2.

At step 310A1, request, by the origin JVM, the local GC for a particular remote JVM. In an embodiment, the local GC in the remote JVMs can exclude a compaction process. In an embodiment, only the remote references in nursery area can be considered in the collecting step (step 310) and the local GC can be executed only for the nursery area.

At step 310A2, select, to execute the local GC, a particular remote JVM which is expected to increase the amount of heap collection in the origin JVM more than other remote JVMs. The particular remote JVM and the other remote JVMs are all included in the set of remote JVMs. In an embodiment, only objects with no local reference can be considered in the collecting step (step 310) and hence, in the selection.

In an embodiment, step 310A2 can include steps 310A2a through 310A2c.

At step 311A2a, select the particular remote JVM from among the set of JVMs based on the particular remote JVM having a largest number of remote references to the origin JVM compared to the other remote JVMs. In an embodiment, only objects with no local reference are considered in the collecting step (step 310) and hence, in the selection.

At step 310A2b, select the particular remote JVM from among the set of JVMs based on the particular remote JVM remotely and transitively referencing a largest total number of objects in the origin JVM compared to the other remote JVMs. In an embodiment, for each of the remote JVMs in the set, a total number of remotely and transitively referenced objects ran be estimated based on a total number of remotely and directly referenced objects. In an embodiment, only objects with no local reference are considered in the collecting step (step 310) and hence, in the selection.

At step 310A2c, select the particular remote JVM from among the set of JVMs based on the particular remote JVM remotely and transitively referencing a largest total size of objects in the origin compared to the other remote JVMs. In an embodiment, for each of the remote JVMs in the set, a total size of remotely and transitively referenced objects can be estimated based on a total size of remotely and directly referenced objects. In an embodiment, only objects with no local reference are considered in the collecting step (step 310) and hence, in the selection.

FIG. 5 shows another exemplary method 500 for distributed garbage collection for an unbalanced workload, in accordance with an embodiment of the present invention. The unbalanced workload is between participating JVMs, which include an origin JVM and one or more remote JVMs.

At step 510, increase an amount of heap collection in an origin JVM by collecting unnecessary remote references to the objects that belong to the origin JVM.

In an embodiment, step 510 includes step 510A.

At step 510A, request, by the origin JVM, the local GC for multiple non-specific remote JVMs from among the set of remote JVMs and execute, by each of the multiple non-specific remote JVMs, the local GC when an execution of the local GC is determined to be effective in increasing the amount of heap collection in the origin JVM. In an embodiment, an effectiveness of the execution of the local GC is estimated based on a total number of remote references to the objects that belong to the origin JVM. In an embodiment, the local GC in the remote JVMs can exclude a compaction process. In an embodiment, only the remote references in a nursery area can be considered in the collecting step (step 510) and the local GC can be executed only for the nursery area.

FIG. 6 shows yet another exemplary method 600 for distributed garbage collection for an unbalanced workload, in accordance with an embodiment of the present invention. The unbalanced workload is between participating JVMs, which include an origin JVM and one or more remote JVMs.

At step 610, increase an amount of heap collection in an origin JVM by collecting unnecessary remote references to the objects that belong to the origin JVM.

In an embodiment, step 610 includes step 610A.

At step 610A, asynchronously execute a local GC in one or more remote JVMs when a heap space in the origin JVM becomes lower than a certain threshold. The local GC in the remote JVMs can exclude a compaction process.

FIG. 7 shows still another exemplary method 700 for distributed garbage collection for an unbalanced workload, in accordance with an embodiment of the present invention. The unbalanced workload is between participating JVMs, which include an origin JVM and one or more remote JVMs.

At step 710, increase an amount of heap collection in an origin JVM by collecting unnecessary remote references to the objects that belong to the origin JVM.

In an embodiment, step 710 includes step 710A.

At step 710A, concurrently execute a local GC in all JVMs, including the origin JVM and one or more remote JVMs, when the local GC is needed (e.g., requested) in any of the JVMs from among the origin JVM and the one or more remote JVMs. The local GC in the remote JVMs can exclude a compaction process.

FIG. 5 shows still yet another exemplary method 700 for distributed garbage collection for an unbalanced workload, in accordance with an embodiment of the present invention. The unbalanced workload is between participating JVMs, which include an origin JVM and one or more remote JVMs.

At step 810, increase an amount of heap collection in an origin JVM by collecting unnecessary remote references to the objects that belong to the origin JVM.

In an embodiment, step 810 includes step 810A.

At step 810A, autonomously execute a local GC in all JVMs, including the origin JVM and one or more remote JVMs, at each iteration of a same algorithm or at a barrier synchronization point. The local GC in the remote JVMs can exclude a compaction process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or an suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as JAVA, SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementation of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the, following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for distributed garbage collection (GC), comprising:
increasing an amount of heap collection in an origin JAVA Virtual Machine (JVM) by collecting unnecessary remote references to objects that belong to the origin JVM,
wherein said collecting step collects the unnecessary remote references by executing a local GC in one or more remote JVMs.

2. The computer-implemented method of claim 1, wherein the one or more remote JVMs form a set of remote JVMs, and wherein the local GC is executed in a particular remote JVM which is expected to increase the amount of heap collection in the origin JVM more than other remote JVMs, the particular remote JVM and the other remote JVMs being comprised in the set of remote JVMs

3. The computer-implemented method of claim 2, wherein the origin JVM requests the local GC for the particular remote JVM.

4. The computer-implemented method of claim 3, wherein the particular remote JVM is selected by the origin JVM from among the set of JVMs based on having a largest number of remote references to the objects that belong to the origin JVM compared to the other remote JVMs.

5. The computer-implemented method of claim 4, wherein only objects with no local reference are considered in selecting the particular remote JVM from among the set of JVMs.

6. The computer-implemented method of claim 3, wherein the particular remote JVM is selected by the origin JVM from among the set of JVMs based on remotely and transitively referencing a largest total number of objects in the origin JVM compared to the other remote JVMs.

7. The computer-implemented method of claim 6, wherein, for each of the remote JVMs in the set, a total number of remotely and transitively referenced objects is estimated based on a total number of remotely and directly referenced objects.

8. The computer-implemented method of claim 6, wherein only objects with no local reference are considered in selecting the particular remote JVM from among the set of JVMs.

9. The computer-implemented method of claim 3, wherein the particular remote JVM is selected by the origin JVM from among the set of JVMs based on remotely and transitively referencing a largest total size of objects in the origin JVM compared to the other remote JVMs.

10. The computer-implemented method of claim 9, wherein, for each of the remote JVMs in the set, a total size of remotely and transitively referenced objects is estimated based on a total size of remotely and directly referenced objects.

11. The computer-implemented method of claim 9, wherein only objects with no local reference are considered in selecting the particular remote JVM from among the set of JVMs.

12. The computer-implemented method of claim 3, wherein only the remote references in a nursery area considered in said collecting step and the local GC is executed only for the nursery area.

13. The computer-implemented method of claim 1, wherein the origin JVM requests the local GC for multiple non-specific remote JVMs from among the set of remote JVMs and each of the multiple non-specific remote JVMs executes the local GC when an execution of the local GC is determined to be effective in increasing the amount of heap collection in the origin JVM.

14. The computer-implemented method of claim 13, wherein an effectiveness of the execution of the local GC is estimated based on a total number of remote references to the origin JVM.

15. The computer-implemented method of claim 14, wherein only the remote references in a nursery area considered in said collecting step and the local GC is executed only for the nursery area.

16. The computer-implemented method of claim 1, wherein the local GC is executed in the one or more remote JVMs, when a local GC in the origin JVM failed to collect enough heap space.

17. The computer-implemented method of claim 1, wherein the local GC is asynchronously executed in the one or more remote JVMs when a heap space in the origin JVM becomes lower than a certain threshold.

18. The computer-implemented method of claim 1, wherein the local GC is concurrently executed in all JVMs, including the origin JVM and the one or more remote JVMs, when the local GC is needed in any of the JVMs from among the origin JVM and the one or more remote JVMs.

19. The computer-implemented method of claim 1, wherein all JVMs, including the origin JVM and the one or more remote JVMs, autonomously execute the local GC at each iteration of a same algorithm or at a barrier synchronization point.

20. The computer-implemented method of claim 1, wherein the local GC excludes a compaction process.

21. (canceled)

22. A computer-implemented method for distributed garbage collection (GC), comprising:
increasing an amount of heap collection in an origin JAVA Virtual Machine (JVM) by collecting unnecessary remote references to the objects that belong to the origin JVM,
wherein said collecting step collects the unnecessary remote references by concurrently executing a local GC in all JVMs, including the origin JVM and one or more remote JVMs, when the local GC is requested in any of the JVMs from among the origin JVM and the one or more remote JVMs.

23. (canceled)

24. A computer-implemented method for distributed garbage collection (GC), comprising:
increasing an amount of heap collection in an origin JAVA Virtual Machine (JVM) by collecting unnecessary remote references to the objects that belong to the origin JVM,
wherein said collecting step collects the unnecessary remote references by autonomously executing a local GC in all JVMs, including the origin JVM and one or more remote JVMs, at each iteration of a same algorithm or at a barrier synchronization point.

25-27. (canceled)
